(19) United States
(12) Patent Application Publication
(10) Pub. No.: US 2015/0114628 A1
(43) Pub. Date: Apr. 30, 2015

(54) Downhole Pressure/Thermal Perturbation Scanning Using High Resolution Distributed Temperature Sensing

(71) Applicants: Jeff Chen, Pearland, TX (US); Chee M. Chok, Houston, TX (US); Xudong Yang, Katy, TX (US)

(72) Inventors: Jeff Chen, Pearland, TX (US); Chee M. Chok, Houston, TX (US); Xudong Yang, Katy, TX (US)

(73) Assignee: BAKER HUGHES INCORPORATED, HOUSTON, TX (US)

(21) Appl. No.: 14/068,732

(22) Filed: Oct. 31, 2013

Related U.S. Application Data
(63) Continuation-in-part of application No. 14/062,547, filed on Oct. 24, 2013.
Application No. 14/062,547 is a continuation-in-part of application No. 14/062,561, filed on Oct. 24, 2013.

(51) Int. Cl. G01V 9/00; E21B 36/00; E21B 47/04

(52) U.S. Cl. CPC G01V 9/005; E21B 47/04; E21B 36/00
USPC 166/250.01; 166/57; 702/11

(57) ABSTRACT

A system, method and computer readable medium for determining a feature in a wellbore is disclosed. A distributed temperature sensing system is disposed along the wellbore. A thermal perturbation is induced along the wellbore. A profile is determined of temperature change in response to the applied thermal perturbation using the distributed temperature sensing system. The feature of the wellbore is determined using the measured temperature profile.

### CROSS REFERENCE TO RELATED APPLICATIONS

The present application is a continuation-in-part of U.S. patent application Ser. No. 14/062,547, filed Oct. 24, 2013 and U.S. patent application Ser. No. 14/062,561, filed Oct. 24, 2013, the contents of which are incorporated herein by reference in their entirety.

### BACKGROUND OF THE DISCLOSURE

1. Field of the Disclosure

The present application relates to wellbore scanning and, in particular, to methods for determining features in a wellbore using a distributed temperature sensing system.

2. Description of the Related Art

Down-hole distributed temperature sensing (DTS) systems may be used to provide a distributed temperature survey along a wellbore. In various applications, DTS has been used to monitor thermal transitions induced by well operations or geological events, or to provide thermal information related to a geology of a formation. Different features of the formation may have different heat conductivities. Therefore, the thermal image that results from the differences in heat conductivity of the features may be used to identify the features. Currently, the ability of DTS systems to detect temperature changes is limited by the temperature sensitivity of the DTS sensor, which is on the order of 1 to 2 degrees Celsius. Perturbations on the order of millidegree level therefore may not be detectable using current DTS systems. Thus, in order to detect temperature variations in a wellbore using current DTS systems, it becomes necessary to induce temperature perturbations that are detectable using current DTS systems. Such temperature perturbations may produce stress on the downhole system which may be damaging to the downhole equipment.

### SUMMARY OF THE DISCLOSURE

In one aspect, the present disclosure provides a method of determining a feature in a wellbore, the method including: disposing a distributed temperature sensing system along the wellbore; inducing a thermal perturbation along the wellbore; determining a profile of temperature change in response to the applied thermal perturbation using the distributed temperature sensing system; and determining the feature of the wellbore using the measured temperature profile.

In another aspect, the present disclosure provides a system for determining a feature in a wellbore, including: a device configured to induce a thermal perturbation along the wellbore; a distributed temperature sensing system disposed along the wellbore and configured to obtain raw temperature data measurements in response to the induced thermal perturbation; a processor configured to: receive the temperature measurements from distributed temperature sensing system, determine a profile of temperature change along the wellbore in response to the induced thermal perturbation, and determine the feature of the wellbore using the determined temperature profile.

In yet another aspect, the present disclosure a non-transitory computer-readable medium including a set of instructions stored thereon which when accessed by a processor, enable the processor to perform a method of determining a feature in a wellbore, the method including: receiving a temperature measurement from a distributed temperature sensing system disposed along the wellbore, the temperature measurement in response to a thermal perturbation induced along the wellbore; determining a profile of temperature change in response to the applied thermal perturbation; and determining the feature of the wellbore using the measured temperature profile.

Examples of certain features of the apparatus and method disclosed herein are summarized rather broadly in order that the detailed description thereof that follows may be better understood. There are, of course, additional features of the apparatus and method disclosed hereinafter that will form the subject of the claims.

### BRIEF DESCRIPTION OF THE DRAWINGS

The present disclosure is best understood with reference to the accompanying figures in which like numerals refer to like elements and in which:

FIG. 1 shows a suitable system for determining a feature in a wellbore using the methods disclosed herein;

FIG. 2 shows an exemplary perturbation sequence that may be produced using an exemplary perturbation source of the system of FIG. 1;

FIG. 3 shows an exemplary data boundary of a localized two-dimensional subspace of a measurement space of temperature data obtained in the wellbore;

FIG. 4 shows a schematic diagram of an iterative self-adaptive filtering process of the present disclosure;

FIG. 5 shows an exemplary scanning image obtained using the perturbation method disclosed herein; and

FIGS. 6A and 6B show scans obtained using one or more pressure perturbations propagating within the wellbore.

### DETAILED DESCRIPTION OF THE DISCLOSURE

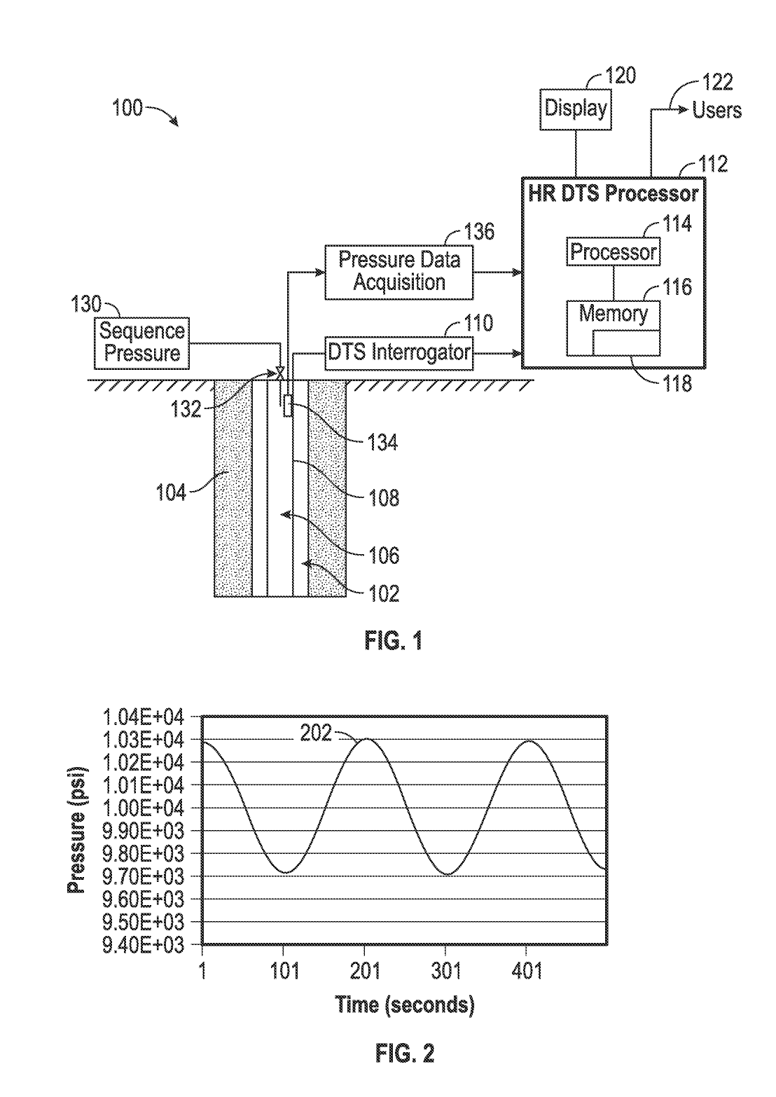

FIG. 1 shows a suitable system 100 for determining a feature in a wellbore 102 using the methods disclosed herein. The wellbore 102 is formed in a formation 104. A member such as a production tubing 106 may be disposed within the wellbore 102. In alternate embodiments, the member may include a drill string, a completion string, or other tubular string. The wellbore system 100 further includes a distributed temperature sensing (DTS) system that is used to obtain a temperature profile along the wellbore 102 over a selected time interval. The DTS system may include a fiber optic cable 108 that extends downhole, generally from a surface location, a Distributed Temperature Sensing interrogator (DTS interrogator) 110 and a High-Resolution Distributed Temperature Sensing processor (HR DTS processor) 112. In one embodiment, fiber optic cable 108 is disposed in the wellbore 102, generally alongside member 106. The fiber optic cable 108 may be either permanently deployed in the wellbore 102 or may be removable from the wellbore 102.

The DTS interrogator 110 obtains raw temperature measurements from the fiber optic cable 108 by generating a short laser pulse that is injected into the fiber optic cable 108 and receiving optical signals from the fiber optic cable 108 in response to the laser pulse injected therein. The obtained optical signals are indicative of temperature. In one embodiment, Raman scattering in the fiber optic cable 108 occurs while the laser pulse travels along the fiber optic cable 108, resulting in a pair of Stokes and anti-Stokes peaks. The anti-Stokes peak is highly responsive to a change in temperature while the Stokes peak is not. A relative intensity of the two peaks therefore provides a measurement indicative of temperature change. The back-reflected Raman scattering (i.e., the Stokes and anti-Stokes peaks) may thus transmit the temperature information of a virtual sensor while the laser pulse is travelling through the fiber optic cable 108. The location of the virtual sensor is determined by the travel time of the returning optical pulse from the DTS interrogator 110 to the virtual sensor and back.

The DTS interrogator 110 therefore obtains raw temperature measurement data (raw data) and sends the raw data to the HR DTS processor 112. The DTS processor 112 performs various methods disclosed herein for increasing a resolution of raw temperature measurements, among other things. The HR DTS processor 112 may include a processor 114 for performing the various calculations of the methods disclosed herein. The HR DTS processor 112 may further include a memory device 116 for storing various data such as the raw data from the DTS interrogator 112 and various calculated results obtained via the methods disclosed herein. The memory device 116 may further include programs 118 containing a set of instructions that when accessed by the processor 114, enable the processor 114 to perform the methods disclosed herein. The HR DTS processor 112 may provide results of the calculations to the memory device 116, a display 120 or to one or more users 122. In various embodiments, the HR DTS processor 112 may wrap the resulting high-resolution DTS data into a managed data format that may be delivered to the users 122. The HR DTS processor 112 may be in proximity to the DTS interrogator 110 to reduce data communication times between the HR DTS processor 112 and the DTS interrogator 110. Alternatively, the HR DTS processor 112 may be remotely connected to the DTS interrogator 110 through a high-speed network.

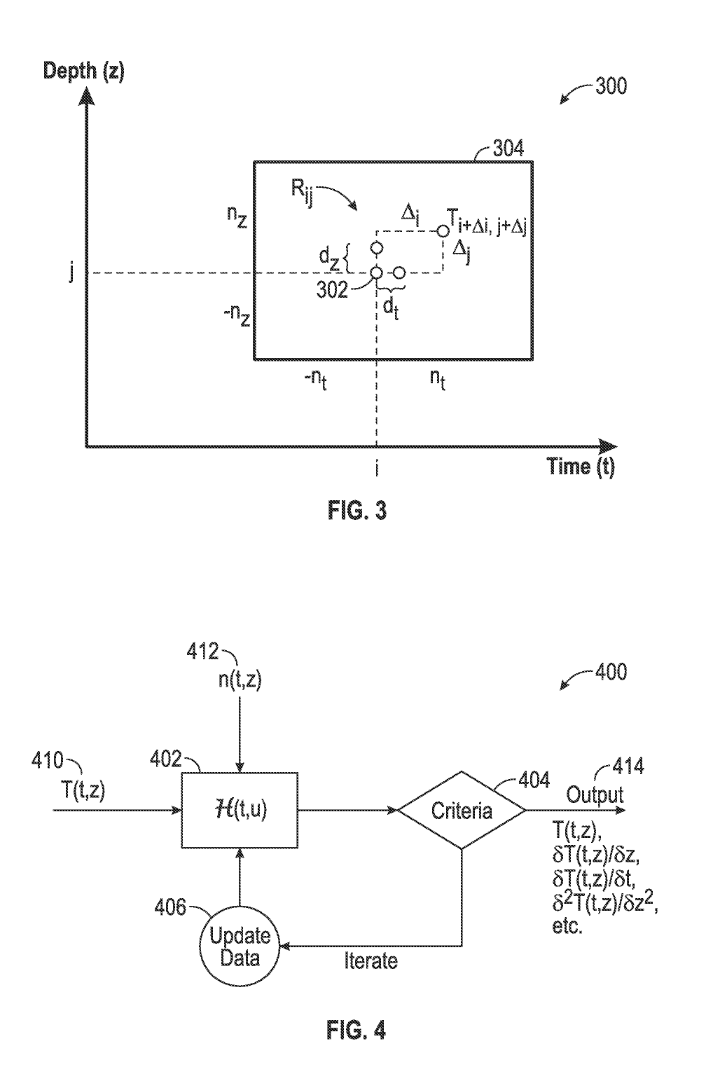

The raw data obtained at the DTS interrogator 110 may include noises at levels that are in a range from one to several degrees Celsius. Such noises may originate due to attenuation loss, noise in the data acquisition system, environmental temperature variations of the fiber optic cable, etc. In one embodiment, the HR DTS processor 112 of the present disclosure applies an adaptive filter disclosed herein to reduce those noises to thereby increase a resolution of the temperature measurements. In one embodiment, the temperature resolution of the data after the filtering methods described herein may be greater than the resolution of the raw temperature measurement data. In an exemplary embodiment, a resolution of raw temperature measurement data that is from about 0.5° C. to about 1.5° C. may be processed using the methods disclosed herein to obtain a post-filtered resolution of about ten millidegrees Celsius. In general, an increase in temperature resolution may be about two orders of magnitude. The adaptive filter is discussed further with respect to FIGS. 3 and 4.

Continuing with FIG. 1, the system 100 includes a perturbation source 130. The perturbation source 130 is tuned to provide a continual sequential disturbance H(t) to the dynamic thermal equilibrium of the downhole environment. In one embodiment, the perturbation source 130 may be a pressure perturbation source that activates a pressure pump 132 either deployed at a surface location or at a location downhole. The pressure source 130 may activate the pressure pump 132 to generate a selected sequence of pressure pulses which propagate along the wellbore 102. The propagating pressure pulse generates a corresponding propagating thermal pulse as a result of the Joule-Thompson effect. The Joule-Thomson effect describes a temperature change of a gas or liquid in relation to its compression or expansion under a changing applied external force such as pressure. For water in the wellbore, each 10 psi pressure change can induce a temperature variation of about 0.015° Celsius. For gases in the wellbore, this temperature variation may be larger by a factor of several tens. The differences in the thermal pressure coefficients of formation solutions, oil or gases may provide temperature changes that may be measured in response to the pressure pulse, thereby enabling scanning of the wellbore 102.

In another embodiment, the perturbation source 130 may include a thermal perturbation source such as a heating cable which may be attached to the production tubing 106 or other member in the wellbore 102 and run along the wellbore 102. The heating cable may similarly be activated by the perturbation source 130 to generate a temperature pulse or perturbation that may propagate along the wellbore 102.

FIG. 2 shows an exemplary perturbation sequence H(t) 202 that may be produced using the exemplary perturbation source 130. The exemplary perturbation sequence 202 provides a pressure perturbation. Time is shown along the abscissa in seconds and pressure is shown along the ordinate in pounds per square inch (psi). The perturbation sequence 202 undergoes a cyclic change. The frequency of the cycle is selected to ensure an image quality obtained from scanning the wellbore 102. The high end of the frequency may be related to a thermal response time of the fiber optic cable 108 or a scan rate of the DTS interrogator 110, whichever is slower. The lower end of the frequency may be related to an overall rate of thermal conduction between two neighboring virtual DTS sensors.

Returning to FIG. 1, the perturbation sequence H(t) is directly measured using a suitable sensor 134, which may be either a pressure sensor or a temperature sensor, depending on the type of perturbation used. The DTS cable 108 is used to record the temperature signals T(t) in response to the perturbation sequence H(t). The temperature signal T(t) is received at the DTS interrogator 110 and sent to HR DTS processor 112 to obtain high resolution temperature data that may be used to determine the features of the wellbore. The temperature signal is a result of heat exchange between the wellbore and its near wellbore formation. The temperature signal therefore carries information on the differences of the heat conductivity of the various features of the wellbore. The two sets of measurements from the pressure data acquisition unit 136 and the DTS interrogator 110 may be synchronized at the HR DTS processor 112 to account for any delay in the DTS response with respect to the perturbation sequence H(t).

For thermal perturbation scanning, the perturbation source 130 provides uniform thermal disturbance along a wellbore. The system 100 predominantly measures the differences in the conductivities of the fluids and the tubular along the heat flow path of the perturbation sequence. The system 100 therefore may measure distributed differentials in thermal conductivity of a completion string or the thermal properties of a fluid in production tubing 106. Since the immediate wellbore environment out of the heat conduction path may also affect the response, features of the immediate wellbore environment or near wellbore environment may also be determined.

The raw temperature measurements T(t) obtained from the system of FIG. 1 exist in a locally-compact measurement space that is correlative and expandable. A two-dimensional measurement space in time and depth for the temperature measurements may be written as:

R(t,z|0<t<∞,−∞<z<∞) Eq. (1)

for which there exists a subspace

R_{i,j}(t,z|tᵢ₋ₙ_{ₜ}<t<tᵢ₊ₙ_{ₜ},zⱼ₋ₙ_{_{z}}<z<zⱼ₊ₙ_{_{z}}) Eq. (2)

(also referred to herein as Rᵢⱼ) where 2nₜ and 2n_{z} are respectively the dimensions for a window defining this subspace within the two-dimensional measurement space.

FIG. 3 shows an exemplary data boundary of a localized two-dimensional subspace Rᵢⱼ of the measurement space. The data boundary may be related to raw temperature measurement data and may be used in the exemplary filtration method described herein to filter the temperature measurements input into the filter. Signal point 302 is plotted as a function of the variables time (t) and depth (z), with the time plotted along the x-axis and the depth plotted along the y-axis. As shown in FIG. 3, exemplary signal point 302 is located at (i,j). In one aspect, window 304 is drawn around and centered at the exemplary signal point 302 to the selected subspace Rᵢⱼ. The dimension of the window 304 may define parameters of the applied filter. The window 304 has dimensions of 2nₜ+1 along the time axis and 2n_{z}+1 along the depth axis and extends from i−nₜ to i+nₜ along the time axis and from j−n_{z} to j+n_{z} along the depth axis. The dimensions of the window 304 may affect a finite impulse response of a filter defined over the measurement subspace.

If nₜ and n_{z} are of a selected size, for a raw temperature measurement T_{i+Δi,j+Δj} which falls into the subspace Rᵢⱼ, a Taylor series expansion may be used to correlate measurements for the current window with that of the center point Tᵢⱼ of the subspace using the following expression:

$${T}_{i + Δ i , j + Δ j} = {T}_{i , j} + {( \frac{\partial T}{\partial t} )}_{i , j} Δ {id}_{t} + {( \frac{\partial T}{\partial z} )}_{i , j} Δ {jd}_{z} + {( \frac{{\partial }^{2} T}{\partial {t}^{2}} )}_{i , j} \frac{{( Δ {id}_{t} )}^{2}}{2} + {( \frac{{\partial }^{2} T}{\partial {z}^{2}} )}_{i , j} \frac{{( Δ {jd}_{z} )}^{2}}{2} + {( \frac{{\partial }^{2} T}{\partial t \partial z} )}_{i , j} \frac{{( Δ i Δ {jd}_{t} {d}_{z} )}^{2}}{2} + … \qquad Eq . ( 3 )$$

where dₜ and d_{z} are respectively the distances along the temporal axis and the spatial axis between two neighboring sensing points within the measurement space, as shown in FIG. 3. Eq. (3) defines a multiple term decomposition of the DTS data, wherein the decomposition includes a Taylor series decomposition having terms of selected orders, e.g. first order terms, second order terms, etc. Each term of the Taylor series decomposition generally has an associated physical meaning and provides a different level of resolution to the raw temperature measurement data. The present disclosure employs a non-orthogonal transform of the Taylor series decomposition of Eq. (3) limited to a selected number of these representations. In one embodiment, terms of the Taylor series composition up to the second order are used and terms that are of orders higher than two are not considered. Equation (3) may thus be rewritten as:

T_{i+Δi,j+Δj}=\vec{H}_{i+Δi,j+Δj}·\vec{T}_{i,j}=Σₖ₌₀⁵h_{Δi,Δj}^{k} [symbol] _{i,j}^{k} Eq. (4)

where \vec{H}_{i,j} denotes a non-orthogonal transformation vector, and \vec{T}_{i,j} denotes a vector containing the terms that are to be determined for the giving point (i,j). A linear reconstruction of the measurement T_{i,j} in the subspace R_{i,j} may be obtained by maximizing the energy compaction for the given transformation vector or, equivalently, by minimizing an expectation value of a linear estimator function:

Σₖ₌₀⁵E[∥Γ_{i,j}^{k}−\hat{Γ}_{i,j}^{k}∥²] Eq. (5)

where \hat{Γ}_{i,j}^{k} is the of Γ_{i,j}^{k} and Γ_{i,j}^{k} is a collection of the k^{th} term of the decomposition of the temperature measurements in subspace Rᵢⱼ. In particular, Γ_{i,j}^{k} are the elements of vector [symbol] _{i,j}^{k}, as illustrated with respect to Eq. (8) below.
Referring back to Eq. (5),

Γ_{i,j}^{k}=Γ_{i,j}^{k-1}−\hat{Γ}_{i,j}^{k-1} Eq. (6)

where Γ_{i,j}⁰=\hat{Γ}_{i,j} is the actual raw temperature measurement (T_{i,j}) in the measurement subspace and which may be a function of time and depth. Eq. (6) defines a generally time-consuming approach to the non-orthogonal transform problem, in which a k^{th} representation is progressively obtained using the (k−1)^{th} representation. However, the present disclosure speeds this process by using a single step approach in which the expectation of the linear estimator function (Eq. (5)) is rewritten as:

Σ_{Δi=-n}_{ₜ}ⁿ^{ₜ}Σ_{Δj=-n}_{_{z}}ⁿ^{_{z}}(T_{i+Δi,j+Δj}−Σₖ₌₀⁵h_{Δ1,Δj}^{k} [symbol] _{i,j}^{k})² Eq. (7)

where [symbol] _{i,j} is a vector containing the following physical quantities:

$${\vec{𝒯}}_{i , j} = {( {T}_{i , j} , {( \frac{\partial T}{\partial t} )}_{i , j} , {( \frac{\partial T}{\partial z} )}_{i , j} , {( \frac{{\partial }^{2} T}{\partial {t}^{2}} )}_{i , j} , {( \frac{{\partial }^{2} T}{\partial {z}^{2}} )}_{i , j} , {( \frac{{\partial }^{2} T}{\partial t \partial z} )}_{i , j} )}^{T} \qquad Eq . ( 8 )$$

defines a linear transfer function:

[symbol]

=H(H^{T}H)⁻¹H^{T} Eq. (9)

with

$$H = ( \begin{matrix}{h}_{- {n}_{t} , - {n}_{z}}^{0} & … & {h}_{- {n}_{t} , - {n}_{z}}^{5} \\ ⋮ & ⋱ & ⋮ \\ {h}_{{n}_{t} , {n}_{z}}^{0} & … & {h}_{{n}_{t} , {n}_{z}}^{5}\end{matrix} ) \qquad Eq . ( 10 )$$

Then, we can obtain the following solution

[symbol]

_{i,j}= [symbol] Γ_{i,j} Eq. (11)

This solution to the Taylor series decomposition may also be viewed as a 2-dimensional filter for digitally filtering the raw temperature measurement data. Since the higher-order terms (i.e., terms of order greater than 2) in the Taylor series decomposition are not considered, [symbol] in Eq. (9) is only an approximate transfer function in which the approximation error depends on the size of subspace Rᵢⱼ. Therefore, a window size suitable for obtaining selected filtration results may be selected. An iterative self-adaptive algorithm, as shown in FIG. 4 achieves this filtration result to a selected approximation error.

FIG. 4 shows a schematic diagram 400 of an iterative self-adaptive filtering process of the present disclosure. The iterative filtering process may be used to provide an accuracy or resolution of temperature measurements to within a selected approximation error. The filtering process preserves transition information for the set of continuous temperature measurement data.

Temperature signal T(t,z) 410 represents a raw DTS temperature measurement obtained from a DTS system which is an input signal to the filter system 300. Noise signal n(t,z) 412 indicates an unknown noise signal accompanying the temperature measurements 410 and which is also input to the filter system 400. In general, the temperature signal 410 and the noise signal 412 are indistinguishable in DTS systems and thus are input to filter 402 as a single measurement. In addition, noise signal n(t,z) 412 is often not constant but changes with changes in environment. Therefore, both temperature signal T(t,z) 410 and noise signal n(t,z) 412 are dependent on time and depth of the measurement location in the DTS system. Output signal 414 is a filtered output signal and may include multiple terms of the decomposition of Eq. (3), such as for

$${T}_{i , j} , {( \frac{\partial T}{\partial t} )}_{i , j} , {( \frac{\partial T}{\partial z} )}_{i , j} ,$$

etc.

In one embodiment, the exemplary filter 402 is a self-adaptive filter using a dynamic window (such as data window 304 in FIG. 3) that may be adjusted to reduce noise in the temperature measurements. The temperature signal 410 and noise signal 412 are fed to filter 402 which provides an approximation to the temperature measurements using the methods disclosed above with respect to Equations (1)-(12). In various embodiments, the approximation may provide values for one or more of terms

$${T}_{i , j} , {( \frac{\partial T}{\partial t} )}_{i , j} , {( \frac{\partial T}{\partial z} )}_{i , j} .$$

A criterion 404 may then be applied to the terms output from the filter 402 to determine an effectiveness of the filter 420. In one embodiment, the selected criterion may be a selected resolution of the temperature measurements or a selected resolution for a selected term of the decomposition. If the filtered terms are found to be within the selected resolution, the filtered terms may be accepted as output signals 414. Otherwise, the filter 402 may be updated at updating stage 406. Updating may include, for example, changing the dimensions of the measurements subspace Rᵢⱼ. In various embodiments, this decomposition process represents DTS measurement data as a Taylor series decomposition that includes terms having various levels of temperature resolution. The first order terms have a resolution that is greater than zero-order terms, etc. The first order terms, which are thermal derivatives in depth or time and the second order derivatives (i.e., variance with respect to depth, variance with respect to time and variance with respect to depth and time) may reach temperature resolutions up to several hundredths of a degree.

Although the methods are discussed with respect to temperature measurements, the present disclosure may also be applied to any suitable signal that is a continuous function measured in a two-dimensional measurement space. While the method is described with respect to a Taylor series decomposition (Eq. (3)), other numerical decompositions may be also used in various alternate embodiments.

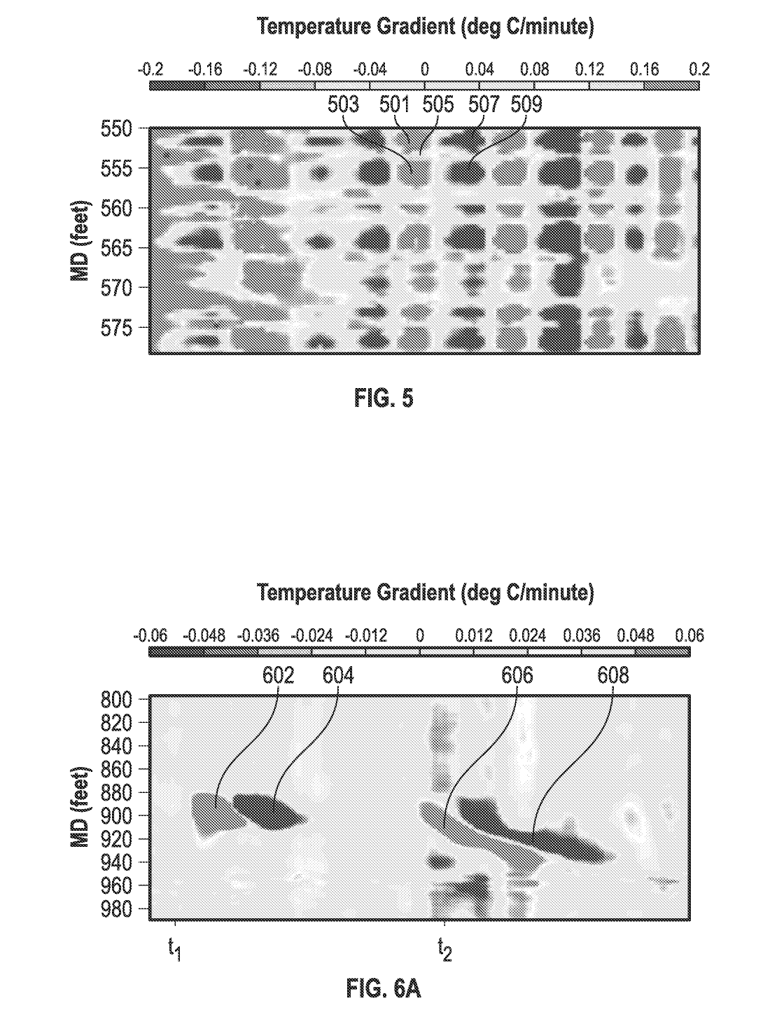

One approach for determining wellbore features may include correlating the perturbation signal H(t) to the temperature signal T(t). Other thermal derivative data provided by a high resolution DTS may also be available to reveal additional feature information. FIG. 5 shows an exemplary scanning image 500 obtained using the perturbation method disclosed herein. The scanning image shows the structural features of a completion string. For example, heating events 501 and 503 show two features of the wellbore that conduct heat in response to the perturbation signal H(t). Segment 505 is relatively unresponsive. The features responsible for heating events 501 and 503 are similarly responsible for respective cooling events 507 and 509. The spatial resolution of such an image may be in the range of several meters. Along the path of an entire wellbore, many features may be observed and monitored for a variety of purposes, such as determining a true depth (formation depth) of a feature, finding a potential leakage, finding a flow assurance problem, etc.

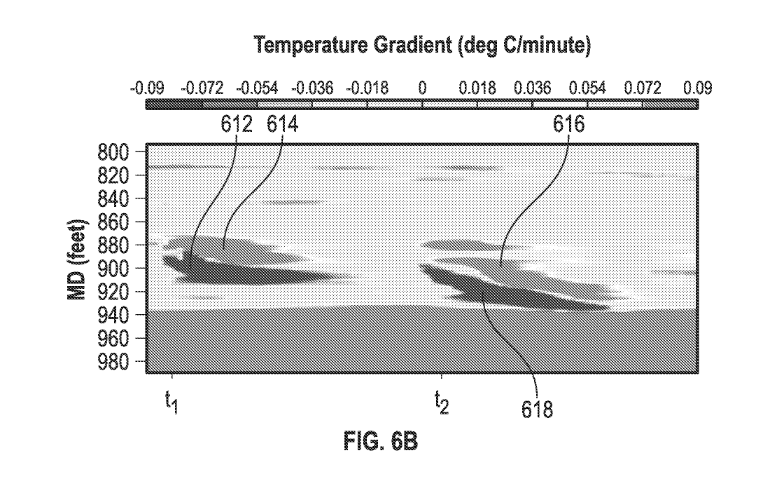

FIGS. 6A and 6B show scans obtained by applying a pressure perturbation to the wellbore, as disclosed herein. FIG. 6A shows a temporal thermal gradient map obtained used the HR DTS methods disclosed herein and FIG. 6B shows a spatial thermal gradient map. The maps of FIG. 6A and FIG. 6B cover the same time frame. Response to a first pressure perturbation and a second pressure perturbation are shown. In FIGS. 6A and 6B, the first 940 feet of depth are in contact with sea water. The first pressure perturbation was imposed in the wellbore at a time t₁ when the sea water is closed to its frozen point, and the second pressure perturbation was imposed in the wellbore 24 hours later (time t₂). FIG. 6A shows a heating event 602 that is generated by the Joule-Thompson effect induced by applying a pressure to the gas hydrate existing in the production tubing. Cooling event 604 is generated when the applied pressure is released. In the second pressure perturbation (at time t₂), heating event 606 is generated by the same Joule-Thompson effect. The corresponding cooling event 608 occurs while the applied pressure is released. The map of FIG. 6A also shows that the gas hydrates moved downward each time when pressure is applied from the surface, and moves down by about 50 feet between the first pressure perturbation at t₁ and second pressure perturbation at t₂.

FIG. 6B shows an exemplary spatial thermal gradient map of the wellbore over the same time frame showing temperature gradient as a function of depth. Region 614 indicates an increase in temperature with depth. Region 612 indicates a decrease in temperature with depths. The pairing of regions 614 and 612 as shown in FIG. 6B, indicates a region with initial increase with depth followed by a decrease with depth. This corresponds to a region of heating or of a concentrated region having a temperature greater than the formation temperature. (If region 612 and 614 were reversed, with region 612 at the higher depth and region 614 at the lower depth, this would indicate a cooling region in the formation.) Therefore, in response to the first pressure perturbation pulse at time t₁, a heating region occurs at the depths from about 880 feet to about 900 feet. Similarly, in response to the second pressure perturbation pulse at time t₂ (as indicated by regions 616 indicating an increase in temperature with depth and region 618 indicating a decrease in temperature with depth) a heating region occurs at depths from about 880 feet to about 920 feet and the heating region moves downhole over time.

Therefore, in an exemplary embodiment, in order to detect flow assurance issues such as the presence of gas hydrate, multiple scans may be obtained at different times. A first scan may be obtained at a time when no flow assurance problems are within the production and may serve as a baseline scan. A second scan may then be run at another time or at a time of a known flow assurance problem. By comparing the first and second scans, the depth location of the assurance problem, e.g., a flow barrier, its type and/or its size may be identified. If a flow assurance issue is significant, it may be directly observed without taking the baseline scan.

In other embodiments, the technique may be further used to determine such as well integrity issues, gas/liquid or liquid/liquid interface, etc.

Therefore, in one aspect, the present disclosure provides a method of determining a feature in a wellbore, the method including: disposing a distributed temperature sensing system along the wellbore; inducing a thermal perturbation along the wellbore; determining a profile of temperature change in response to the applied thermal perturbation using the distributed temperature sensing system; and determining the feature of the wellbore using the measured temperature profile. Inducing the thermal perturbation further may include at least one of: generating a pressure perturbation in a fluid in the wellbore and generating the temperature perturbation using a heating element disposed along the wellbore. The pressure perturbation may include a pressure wave that propagates along the wellbore. The pressure wave may be generated by a pressure oscillator disposed at one of a downhole location and a surface location. The feature of the wellbore may be a component of a work string in the wellbore; a near wellbore feature of the formation; a gas hydrate formation in a fluid flowing in a production string in the wellbore; a flow assurance barrier; a liquid-liquid interface; a gas-liquid interface; an unexpected release of gases or fluids; a well leakage, etc. The feature may be determined with respect to a formation depth. When a magnitude of the induced thermal perturbation is less than a resolution of the distributed temperature sensing system, the method may perform data processing to obtain a temperature resolution of the thermal perturbation that is greater than the resolution of the distributed temperature sensing system. The obtained temperature resolution may be in a range from several millidegrees Celsius to several degrees Celsius, such as from about 1-2 millidegree Celsius to about 1-2 degrees Celsius.

In another aspect, the present disclosure provides a system for determining a feature in a wellbore, including: a device configured to induce a thermal perturbation along the wellbore; a distributed temperature sensing system disposed along the wellbore and configured to obtain raw temperature data measurements in response to the induced thermal perturbation; a processor configured to: receive the temperature measurements from distributed temperature sensing system, determine a profile of temperature change along the wellbore in response to the induced thermal perturbation, and determine the feature of the wellbore using the determined temperature profile. The device may be further configured to induce the thermal perturbation by at least one of: generating a pressure perturbation in a fluid in the wellbore, and activating a heating element disposed along the wellbore. The pressure perturbation may include a pressure wave that propagates along the wellbore. The device may be located at a downhole location or a surface location. The feature of the wellbore may be a component of a work string in the wellbore; a near wellbore feature of the formation; a gas hydrate formation in a fluid flowing in a production string in the wellbore; an other flow assurance barrier; a liquid-liquid interface; a gas-liquid interface; an unexpected release of gases or fluids; a well leakage, etc. The processor may further determine a formation depth of the feature. The device may induce a thermal perturbation with a magnitude less than a resolution of the distributed temperature sensing system. Thus, the processor performs digital processing to obtain a temperature resolution of the thermal perturbation that is greater than the resolution of the distributed temperature sensing system.

In yet another aspect, the present disclosure provides a non-transitory computer-readable medium including a set of instructions stored thereon which when accessed by a processor, enable the processor to perform a method of determining a feature in a wellbore, the method including: receiving a temperature measurement from a distributed temperature sensing system disposed along the wellbore, the temperature measurement in response to a thermal perturbation induced along the wellbore; determining a profile of temperature change in response to the applied thermal perturbation; and determining the feature of the wellbore using the measured temperature profile. The induced thermal perturbation may include a pressure perturbation generated in a fluid in the wellbore or a temperature perturbation generated using a heating element disposed along the wellbore. The pressure perturbation may further include a pressure wave that propagates along the wellbore. The feature of the wellbore may include: a component of a work string in the wellbore; a near wellbore feature of the formation; a gas hydrate formation in a fluid flowing in a production string in the wellbore; an other flow assurance barrier; a liquid-liquid interface; a gas-liquid interface; an unexpected release of gases or fluids; a well leakage, etc. The induced thermal perturbation may be less than a resolution of the distributed temperature sensing system. Thus, the method performs digital data processing to obtain a temperature resolution of the thermal perturbation that is greater than the resolution of the distributed temperature sensing system.

While the foregoing disclosure is directed to the preferred embodiments of the disclosure, various modifications will be apparent to those skilled in the art. It is intended that all variations within the scope and spirit of the appended claims be embraced by the foregoing disclosure.

What is claimed is:

1. A method of determining a feature in a wellbore, comprising:
disposing a distributed temperature sensing system along the wellbore;
inducing a thermal perturbation along the wellbore;
determining a profile of temperature change in response to the applied thermal perturbation using the distributed temperature sensing system; and
determining the feature of the wellbore using the measured temperature profile.

2. The method of claim 1 wherein inducing the thermal perturbation further comprises at least one of: generating a pressure perturbation in a fluid in the wellbore and generating the temperature perturbation using a heating element disposed along the wellbore.

3. The method of claim 2, wherein the pressure perturbation is a pressure wave that propagates along the wellbore.

4. The method of claim 3, wherein the pressure wave is generated by a pressure oscillator disposed at one of: a downhole location; and a surface location.

5. The method of claim 1, wherein the feature of the wellbore is at least one of: a component of a work string in the wellbore; a near wellbore feature of the formation; a gas hydrate formation in a fluid flowing in a production string in the wellbore; a flow assurance barrier; a liquid-liquid interface; a gas-liquid interface; an unexpected release of gases or fluids; and a well leakage.

6. The method of claim 1, further comprising determining the feature with respect to a formation depth.

7. The method of claim 1, wherein a magnitude of the induced thermal perturbation is less than a resolution of the distributed temperature sensing system, further comprising performing data processing to obtain a temperature resolution of the thermal perturbation that is greater than the resolution of the distributed temperature sensing system.

8. The method of claim 1, wherein the obtained temperature resolution is in a range from a millidegree Celsius to a degree Celsius.

9. A system for determining a feature in a wellbore, comprising:
a device configured to induce a thermal perturbation along the wellbore;
a distributed temperature sensing system disposed along the wellbore and configured to obtain raw temperature data measurements in response to the induced thermal perturbation;
a processor configured to:
receive the temperature measurements from distributed temperature sensing system,
determine a profile of temperature change along the wellbore in response to the induced thermal perturbation, and
determine the feature of the wellbore using the determined temperature profile.

10. The system of claim 8, n wherein the device is further configured to induce the thermal perturbation by at least one of: generating a pressure perturbation in a fluid in the wellbore, and activating a heating element disposed along the wellbore.

11. The system of claim 9, wherein the pressure perturbation is a pressure wave that propagates along the wellbore.

12. The system of claim 10, wherein the device is located at one of: a downhole location; and a surface location.

13. The system of claim 8, wherein the feature of the wellbore is at least one of: a component of a work string in the wellbore; a near wellbore feature of the formation; a gas hydrate formation in a fluid flowing in a production string in the wellbore; an other flow assurance barrier; a liquid-liquid interface; a gas-liquid interface; an unexpected release of gases or fluids; and a well leakage.

14. The system of claim 9, wherein the processor is further configured to determine a feature with respect to formation depth.

15. The system of claim 8, wherein the device is configured to induce a thermal perturbation with a magnitude less than a resolution of the distributed temperature sensing system and the processor is configured to perform digital processing to obtain a temperature resolution of the thermal perturbation that is greater than the resolution of the distributed temperature sensing system.

16. A non-transitory computer-readable medium including a set of instructions stored thereon which when accessed by a processor, enable the processor to perform a method of determining a feature in a wellbore, the method comprising:
receiving a temperature measurement from a distributed temperature sensing system disposed along the wellbore, the temperature measurement in response to a thermal perturbation induced along the wellbore;
determining a profile of temperature change in response to the applied thermal perturbation; and
determining the feature of the wellbore using the measured temperature profile.

17. The computer-readable medium of claim 15, wherein the induced thermal perturbation further comprises at least one of: a pressure perturbation generated in a fluid in the wellbore and a temperature perturbation generated using a heating element disposed along the wellbore.

18. The computer-readable medium of claim 16, wherein the pressure perturbation is a pressure wave that propagates along the wellbore.

19. The computer-readable medium of claim 1, wherein the feature of the wellbore is at least one of: a component of a work string in the wellbore; a near wellbore feature of the formation; a gas hydrate formation in a fluid flowing in a production string in the wellbore; an other flow assurance barrier; a liquid-liquid interface; a gas-liquid interface; an unexpected release of gases or fluids; and a well leakage.

20. The computer-readable medium of claim 1, wherein the induced thermal perturbation is less than a resolution of the distributed temperature sensing system, the method further comprising performing digital data processing to obtain a temperature resolution of the thermal perturbation that is greater than the resolution of the distributed temperature sensing system.
